(19) United States
(12) Patent Application Publication
(10) Pub. No.: US 2009/0266790 A1
(43) Pub. Date: Oct. 29, 2009

(54) METHOD OF MAKING A MAGNETORESISTIVE READER STRUCTURE

(76) Inventors: Hamid Balamane, Portola Valley, CA (US); Jordan A. Katine, Mountain View, CA (US); Jui-Lung Li, San Jose, CA (US); Neil L. Robertson, Palo Alto, CA (US)

Correspondence Address: PATTERSON & SHERIDAN, L.L.P., 3040 POST OAK BLVD., SUITE 1500, HOUSTON, TX, 77056, US

(21) Appl. No.: 12/110,388

(22) Filed: Apr. 28, 2008

(51) Int. Cl. B44C 1/22

(52) U.S. Cl. 216/22

(57) ABSTRACT

A method of making a magnetoresistive sensor includes defining a track width of a magnetoresistive element stack of the sensor with a hard mask and photoresist. Further, processes of the method enable depositing of hard magnetic bias material on each side of the stack after the hard mask used to define the track width is removed. A separate chemical mechanical polishing (CMP) stop layer that is different from the hard mask enables subsequent creating of a planar surface via CMP to remove unwanted material on top of the sensor stack.

### BACKGROUND OF THE INVENTION

1. Field of the Invention

Embodiments of the invention generally relate to methods of making a magnetoresistive reader structure for sensing data stored on magnetic media.

2. Description of the Related Art

In an electronic data storage and retrieval system, a magnetic head typically includes a reader portion having a magnetoresistive (MR) sensor for retrieving magnetically encoded information stored on a magnetic recording medium or disk. The MR sensor includes multiple layers and operates based on a change of resistance of the MR sensor in the presence of a magnetic field. During a read operation, a bias current is passed through the MR sensor. Magnetic flux emanating from a surface of the recording medium causes rotation of a magnetization vector of a sensing or free layer of the MR sensor, which in turn causes the change in resistance of the MR sensor. The change in resistance of the read element is detected by passing a sense current through the read element, and then measuring the change in bias voltage across the read element to generate a read signal. This signal can then be converted and manipulated by an external circuitry as necessary. A hard magnetic bias structure can be used to stabilize the magnetic movement of the free layer to provide a noise-free response from the MR sensor. In construction of the MR sensor, depositing hard bias layers on both sides of the MR sensor accomplishes this stabilization.

As storage density on the recording medium increases, a track width of the MR sensor must be made narrower to enable accurate read sensitivity. Signal resolution depends on the track width of the MR sensor being narrower than track spacing on the recording medium. Several prior approaches for defining the track width of the MR sensor exist but have disadvantages.

Therefore, there exists a need for processes of fabricating narrow magnetoresistive sensors to improve properties of the sensors.

### SUMMARY OF THE INVENTION

In one embodiment, a method of forming a magnetoresistive (MR) read sensor begins with a MR sensor stack having a polish resistant layer and a hard mask layer that are both disposed above the MR sensor stack. The method includes patterning the hard mask layer utilizing a patterned photoresist, removing a portion of the MR sensor stack unprotected by the hard mask layer that is patterned to define a track width of the MR read sensor, and removing the hard mask layer from above the MR sensor stack once the portion of the MR sensor stack is removed. Then, the method further includes depositing a hard bias layer above the MR sensor stack and at both lateral sides of the MR sensor stack within voids defined by the portion removed and chemical mechanical polishing the hard bias layer until reaching the polish resistant layer.

For one embodiment, a method of forming a MR read sensor from a read sensor stack on a magnetic bottom shield includes depositing an electrically conductive cap layer on the read sensor stack with the cap layer selected to have a lower polishing rate than a hard bias layer. Further, the method includes depositing a hard mask layer on the cap layer, developing a photoresist patterned on the hard mask layer, reactive ion etching the mask layer where the photoresist is patterned, removing the photoresist, ion milling the read sensor stack that is unprotected by the mask layer except where a track width is defined, reactive ion etching the hard mask layer remaining on the cap layer, and depositing, on the cap layer and both sides of the read sensor stack where the ion milling left voids, an insulation layer and then the hard bias layer. Chemical mechanical polishing the hard bias and insulation layers removes the hard bias and insulation layers from the cap layer and produces a planar top surface to enable plating a magnetic top shield above the read sensor stack and the hard bias layer that remains following the polishing.

According to one embodiment, a method of forming a MR read sensor includes providing a MR sensor stack with a polishing stop layer containing one of rhodium (Rh) and chromium (Cr) disposed above the MR sensor stack and a patterned mask layer containing amorphous diamond-like carbon disposed above the polishing stop layer. Ion milling the MR sensor stack occurs where unprotected by the mask layer. After which, reactive ion etching the mask layer removes the patterned mask layer prior to depositing hard bias magnetic material on the polishing stop layer and at sides of the MR sensor stack within voids defined by the ion milling. The method further includes polishing to produce a planar top surface defined in part by the polishing stop layer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of a hard disk drive including a magnetic head, according to embodiments of the invention.

FIG. 2 is a cross-sectional diagrammatic view of a partially completed structure that when finished forms the read element of the magnetic head and includes, at a stage depicted, a read sensor stack above a first shield, a chemical mechanical polishing (CMP) stop layer above the read sensor stack, a hard mask layer above the CMP stop layer and a patterned photoresist above the hard mask layer, according to embodiments of the invention.

FIG. 3 is a cross-sectional diagrammatic view of the structure, at one of several succeeding stages shown in order herein to depict manufacturing progression, after reactive ion etching (R.I.E.) the portion of the hard mask layer unprotected by the photoresist and then stripping off the photoresist, according to embodiments of the invention.

FIG. 4 is a cross-sectional diagrammatic view of the structure post ion milling of the read sensor stack to define a track width of the magnetic read element, according to embodiments of the invention.

FIG. 5 is a cross-sectional diagrammatic view of the structure following R.I.E. to remove the hard mask layer that remains, according to embodiments of the invention.

FIG. 6 is a cross-sectional diagrammatic view of the structure upon depositing an insulation layer, a hard bias layer and a capping layer on both sides of the read sensor stack and subsequent CMP, according to embodiments of the invention.

FIG. 7 is a cross-sectional diagrammatic view of the structure after ion milling of the capping layer and the CMP stop layer and deposition of a second shield, according to embodiments of the invention.

FIG. 8 is a flow chart illustrating a method of making the structure depicted in FIGS. 2-7, according to embodiments of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

Embodiments of the invention relate to methods of making a magnetoresistive sensor. The method includes defining a track width of a magnetoresistive element stack of the sensor with a hard mask and photoresist. Further, processes of the method include depositing of hard magnetic bias material on each lateral side of the stack after the hard mask used to define the track width is removed. A separate chemical mechanical polishing stop layer that is different from the hard mask allows a planar surface to be subsequently created via chemical mechanical polishing that removes unwanted material on top of the sensor stack.

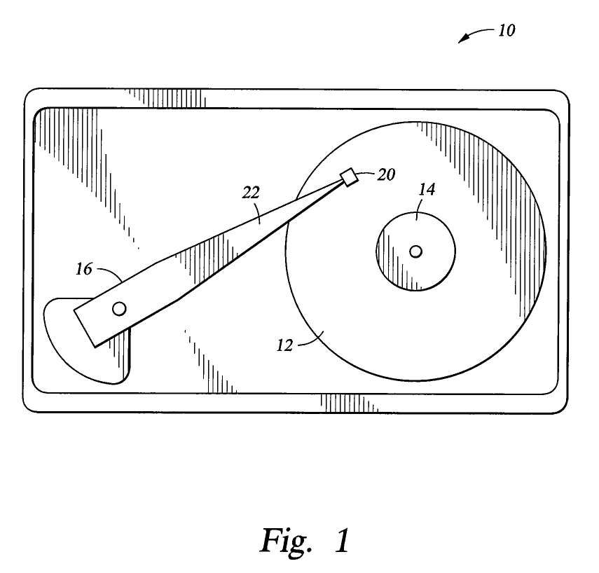

FIG. 1 illustrates a hard disk drive 10 that includes a magnetic media hard disk 12 mounted upon a motorized spindle 14. An actuator arm 16 is pivotally mounted within the hard disk drive 10 with a magnetic head 20 disposed upon a distal end 22 of the actuator arm 16. During operation of the hard disk drive 10, the hard disk 12 rotates upon the spindle 14 and the magnetic head 20 acts as an air bearing slider adapted for flying above the surface of the disk 12. As described hereinafter, the magnetic head 20 includes a substrate base upon which various layers and structures that form the magnetic head 20 are fabricated. Thus, magnetic heads disclosed herein can be fabricated in large quantities upon a substrate and subsequently sliced into discrete magnetic heads for use in devices such as the hard drive 10.

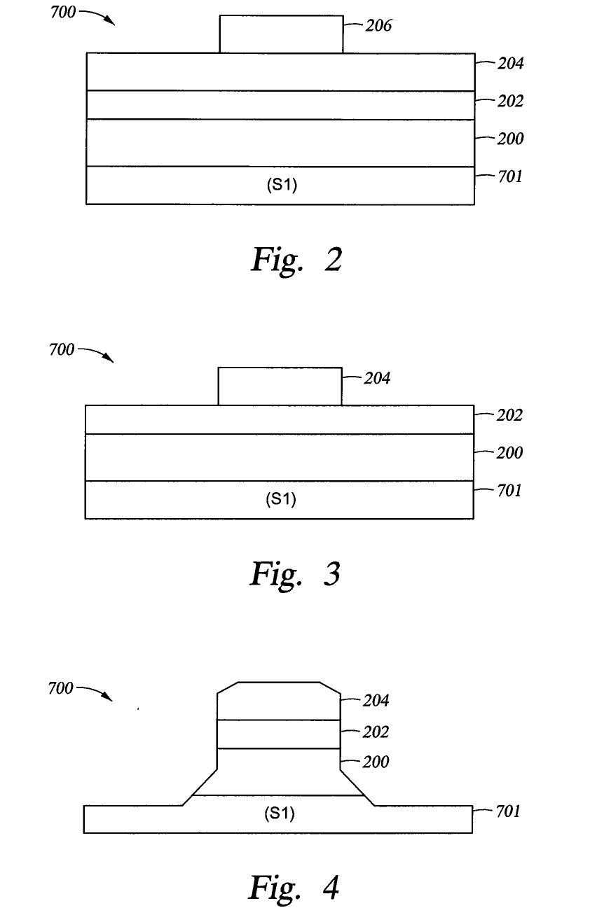

A read portion of the magnetic head 20 includes a read sensor between magnetic bottom (S1) and top (S2) shields 701, 702 (both shown in FIG. 7). For some embodiments, the read sensor is a giant magnetoresistive (GMR) sensor or a tunnel magnetoresistive (TMR) sensor, is a current-perpendicular-to-plane (CPP) type and has a plurality of magnetic and nonmagnetic layers (hereinafter “MR element stack” depicted schematically by reference number 200 in FIGS. 2-7). A magnetic hard bias layer 600 (shown in FIGS. 6 and 7) of the read sensor provides a longitudinal magnetic bias to align a ferromagnetic free layer of the MR element stack 200 in a single domain state. The following describes in detail methods of producing this read sensor of the magnetic head 20.

FIG. 2 shows a structure 700 that is partially completed and that when finished (as shown in FIG. 7) forms part of the read sensor of the magnetic head 20. FIGS. 3-7 illustrate several succeeding stages shown in order to depict manufacturing progression of the structure 700. At a stage depicted in FIG. 2, the structure 700 includes the MR element stack 200 formed above the bottom shield 701, a cap or CMP stop layer 202 and a hard mask layer 204 both deposited above the MR element stack 200, and a patterned photoresist 206 above the hard mask layer 204. The width of the photoresist 206 as a result of being patterned provides the magnetic head 20 with a corresponding track width where the photoresist 206 is above only part of the MR element stack 200 that is otherwise not covered by the photoresist 206. In some embodiments, the photoresist 206 contains silicon and may be a photosensitive polymer. In other embodiments, the resist 206 may be an electron-beam sensitive polymer.

The structure 700 is formed by stacking a plurality of layers in a direction away from the bottom shield 701 (i.e., in a direction normal to the bottom shield 701). For purposes of illustration, relative terms of orientation are used to describe the structure 700. For example, the bottom shield is at a “lower” end of the structure 700, while the photoresist 206 is at an “upper” end of the structure 700. It is understood, however, that terms such as “bottom,” “upper” and “lower” are merely used for illustration and are not limiting of the invention. Illustratively, the MR element stack 200 has an upper surface and a lower surface parallel to each other; similarly, the photoresist 206 and the mask layer 204 each have respective upper and lower surfaces parallel to each other. The lower surface of the photoresist 206 is relatively closer to the MR element stack 200 than the upper surface of the photoresist 206 and is in facing relation to the upper surface of the MR element stack 200. It is contemplated that the lower surface of the photoresist 206 is in direct contact with the upper surface of the MR sensor stack 200. Alternatively, the lower surface of the photoresist 206 and the upper surface of the MR sensor stack 200 are separated from one another by one or more intermediate layers.

FIG. 3 illustrates the structure 700 after reactive ion etching (R.I.E.) the hard mask layer 204 and then stripping off the photoresist 206. The R.I.E. removes the hard mask layer 204 at regions unprotected by the photoresist 206. For some embodiments, the hard mask layer 204 includes amorphous carbon in the form of diamond like carbon (DLC) with a thickness of about 30 nanometers (nm) to about 50 nm. Regardless of composition of the hard mask layer 204, characteristics of the hard mask layer 204 include capability to act as a mill mask and ability to be removed by R.I.E. Stripping of the photoresist 206 in some embodiments utilizes a chemical or other process to strip off the photoresist 206 from the hard mask layer 204 after the R.I.E.

FIG. 4 shows the structure 700 post ion milling of the MR element stack 200 to define the track width. The ion milling mills through both the CMP stop layer 202 and at least part of the MR element stack 200 where not protected by the hard mask layer 204. Lateral sidewalls of the structure 700 need not be parallel since the ion milling may result, as shown, in a lower portion of the sidewall tapering inward to where the sidewall becomes parallel for an upper portion. Some of the hard mask layer 204 may also erode during the ion milling. The thickness of the hard mask layer 204 may enable such erosion without the hard mask layer 204 being eroded away to the point that desired coverage by the hard mask layer 204 is lost anywhere over the CMP stop layer 202. Ability to utilize desirable thicknesses of the hard mask layer 204 insures that even edges of the MR element stack 200 are not affected by the erosion of the hard mask layer 204.

By comparison, a hard mask used with other approaches may create undesired topography in subsequent steps as thickness of the hard mask is increased to compensate for this erosion. For example, the hard mask may, due to its thickness, contribute to shadowing during deposition of hard bias materials if the hard mask is not removed prior to the deposition of the hard bias materials. Use of the hard mask in these other approaches to provide a CMP stop itself after the deposition of the hard bias materials however prevents removal of the hard mask before the deposition of the hard bias materials. The shadowing results in different thicknesses of the hard bias materials where deposited and, hence, undesired asymmetry. Further, undesired topography may result at an interface between the hard bias material and a sensing structure such as the MR element stack 200 since following the CMP the hard mask is removed to enable electrical contact with the sensing structure. R.I.E. of the hard mask after the CMP creates, relative to the hard bias material, a recess corresponding to the thickness of the hard mask taken out by the R.I.E. The top shield dips in at the recess when the top shield is plated creating magnetic domains that are adjacent the sensing structure and cause noise.

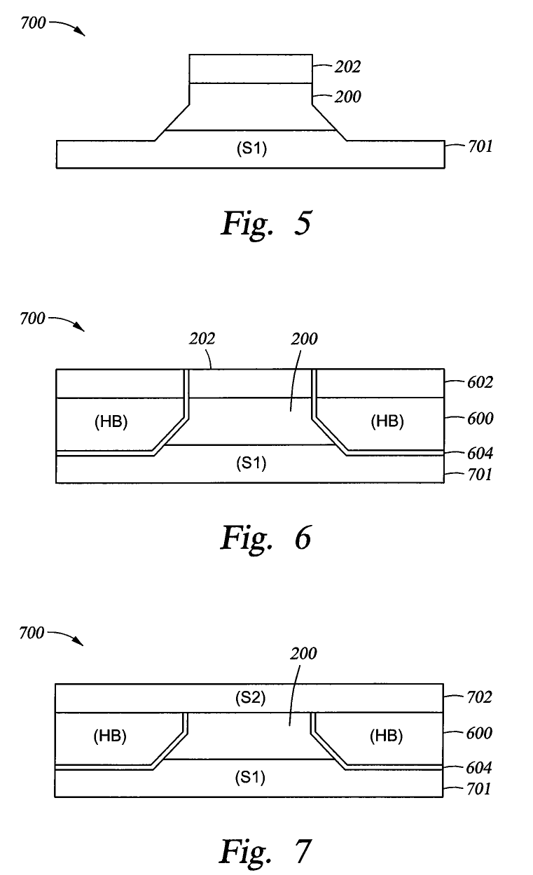

FIG. 5 shows the structure 700 following R.I.E. to remove the hard mask layer 204 that remains. Complete removal of the hard mask layer 204 above the MR element stack 200 occurs leaving the CMP stop layer 202 above the MR element stack 200. For some embodiments, a metal such as chromium (Cr) or rhodium (Rh) forms the CMP stop layer 202 that has a thickness of about 5 nm to about 15 nm. In some embodiments, the CMP stop layer 202 includes multiple layers of different materials such that a bottom portion polishes at a different rate than a top portion. Regardless of composition of the CMP stop layer 202, characteristics of the CMP stop layer 202 include resistance to R.I.E., electrical conductivity, and a lower CMP rate than material of the hard bias layer 600. The electrical conductivity of the CMP stop layer 202 ensures that the CMP stop layer 202 does not impede sensing when the structure 700 is in use. During the ion milling, the hard mask layer 204 protects the CMP stop layer 202 to maintain the thickness of the CMP stop layer 202 above the MR element stack 200 without distortion in shape of the CMP stop layer 202. For some embodiments, the hard mask layer 204 differs from the CMP stop layer 202 by being non-conductive and thicker than the CMP stop layer 202.

FIG. 6 illustrates the structure 700 upon depositing an electrical insulating layer 604, the hard bias layer 600, and a capping layer 602 on both lateral sides of the MR element stack 200 and subsequent CMP of the structure 700. In one embodiment, an insulating layer 604 separates the MR element stack 200 from the hard bias layer 600. In a particular embodiment, the insulating layer 604 may include alumina, and may also include one or more seed layers. The insulating layer 604 may be deposited by ion beam deposition or atomic layer deposition, for example. Then, the hard bias layer 600 and the capping layer 602 are ion beam deposited. Upon this deposition, the insulating layer 604, the hard bias layer 600, and the capping layer 602 initially define a peak above the MR element stack 200. Removal of this peak occurs by utilizing CMP procedures to planarize the structure 700 down to the CMP stop layer 202 that identifies an endpoint for the CMP procedures. Adjacent the MR element stack 200, all of the hard bias layer 600 may remain as only part of the capping layer 602 may be removed in this region during the CMP.

For some embodiments, cobalt platinum (CoPt), other cobalt alloys, or other cobalt platinum alloys provide the hard bias layer 600. In some embodiments, a metal such as tantalum (Ta) or the same material as the CMP stop layer 202 forms the capping layer 602, which is about 5 nm to about 15 nm thick or about the same thickness as the CMP stop layer 202. The capping layer 602 may polish at approximately the same rate as the hard bias layer 600 or at a slower rate than the hard bias layer 600 and may provide nonmagnetic material above magnetic material of the hard bias layer 600. Further, the capping layer 602 may etch with ion milling at about the same rate as the CMP stop layer 202 to avoid producing an undesirable topography on the structure 700 in subsequent steps.

FIG. 7 illustrates the structure 700 completed by performing ion milling of the capping layer 602 on each side of the MR element stack 200 and the CMP stop layer 202 above the MR element stack 200. The ion milling prepares the capping layer 602 and the CMP stop layer 202 for plating of the top shield 702. Prior to depositing an optional non-magnetic spacer layer onto which the top shield 702 is plated, the milling may remove part or all of the capping layer 602 and the CMP stop layer 202 without milling into MR element stack 200. For some embodiments, plating of the top shield 702 occurs above a portion of the capping layer 602 and the CMP stop layer 202 that remains following the milling. As the final step prior to plating of the top shield 702, a conductive, magnetic seedlayer may be deposited over the entire wafer. In some embodiments, nickel iron alloys form both the seedlayer and the top shield 702.

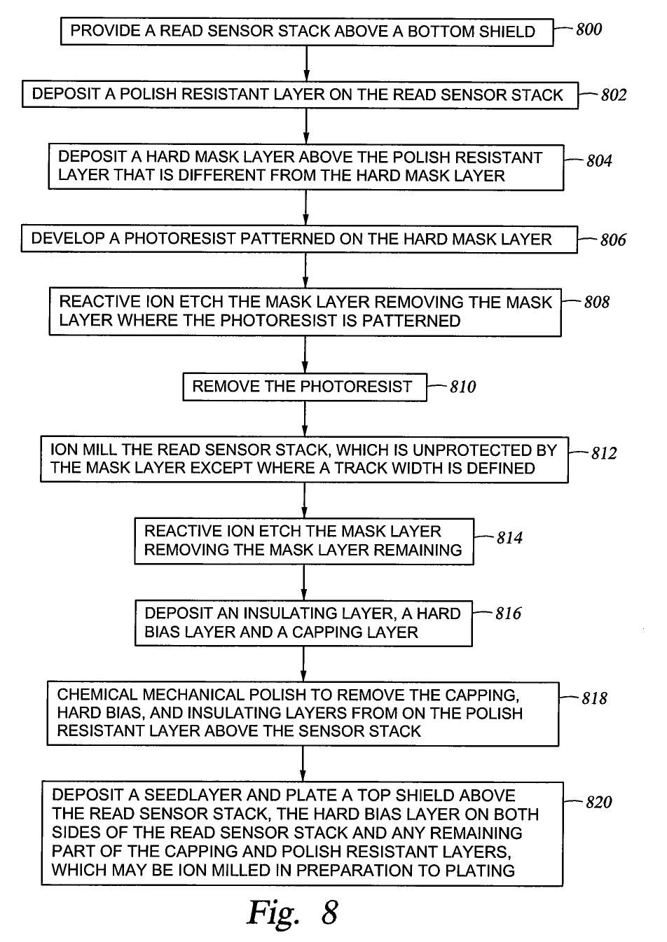

FIG. 8 shows a flow chart for a method of making the structure depicted in FIGS. 2-7. The method includes providing a read sensor stack (step 800), depositing a CMP stop layer on the read sensor stack (step 802), and then depositing a hard mask layer on the CMP stop layer (804). Developing a photoresist patterned on the hard mask layer (step 806) facilitates reactive ion etching the mask layer to remove the mask layer where the photoresist is patterned (step 808). Thereafter, the photoresist is removed (step 810). Ion milling the read sensor stack that is unprotected by the mask layer except where a track width is defined (step 812) occurs prior to removal of the hard mask layer remaining by reactive ion etching (step 814).

Next, depositing an insulating layer, a hard bias layer on the insulation layer, and a capping layer on the hard bias layer fills in on both sides of the read sensor stack where milling left voids (step 816). Subsequently, chemical mechanical polishing the hard bias layer planarizes the structure to remove deposited material from on the CMP stop layer above the sensor stack (step 818). While another reactive ion milling operation may remove a portion of the capping layer and the CMP stop layer, plating of the top shield completes the structure (step 820).

While the foregoing is directed to embodiments of the present invention, other and further embodiments of the invention may be devised without departing from the basic scope thereof, and the scope thereof is determined by the claims that follow.

What is claimed is:

1. A method of forming a magnetoresistive (MR) read sensor, comprising:
providing a MR sensor stack with a polish resistant layer and a hard mask layer that are both disposed above the MR sensor stack;
patterning the hard mask layer utilizing a patterned photoresist;
removing a portion of the MR sensor stack unprotected by the hard mask layer that is patterned to define a track width of the MR read sensor;
removing the hard mask layer from above the MR sensor stack once the portion of the MR sensor stack is removed;
then, depositing a hard bias layer above the MR sensor stack and at both lateral sides of the MR sensor stack within voids defined by the portion removed; and
chemical mechanical polishing the hard bias layer until reaching the polish resistant layer.

2. The method of claim 1, further comprising depositing an electrical insulation layer on the polish resistant layer and both sides of the MR sensor stack, wherein the hard bias layer is deposited on the insulation layer.

3. The method of claim 1, further comprising depositing a nonmagnetic capping layer on the hard bias layer.

4. The method of claim 3, wherein top surfaces of the capping layer and the polish resistant layer are coplanar following the polishing.

5. The method of claim 3, wherein the capping layer comprises tantalum (Ta).

6. The method of claim 1, wherein the hard mask layer comprises diamond like carbon.

7. The method of claim 1, wherein the polish resistant layer is metallic.

8. The method of claim 1, wherein the polish resistant layer is electrically conductive.

9. The method of claim 1, wherein the polish resistant layer comprises one of rhodium (Rh) and chromium (Cr).

10. The method of claim 1, wherein removing the portion of the MR sensor stack comprises ion milling.

11. The method of claim 1, wherein removing the hard mask layer from above the MR sensor stack comprises reactive ion etching.

12. The method of claim 1, further comprising ion milling of the polish resistant layer.

13. The method of claim 1, further comprising depositing a magnetic top shield above the read sensor stack and the hard bias layer that remains following the polishing.

14. The method of claim 1, wherein the polish resistant layer is thinner than the hard mask layer, which has a thickness of at least 30 nanometers.

15. A method of forming a magnetoresistive (MR) read sensor, comprising:
providing a read sensor stack on a magnetic bottom shield;
depositing an electrically conductive cap layer on the read sensor stack, wherein the cap layer has a lower polishing rate than a hard bias layer;
depositing a hard mask layer on the cap layer;
developing a photoresist patterned on the hard mask layer;
reactive ion etching the mask layer where the photoresist is patterned;
removing the photoresist;
ion milling the read sensor stack that is unprotected by the mask layer except where a track width is defined;
reactive ion etching the hard mask layer remaining on the cap layer;
depositing, on the cap layer and both sides of the read sensor stack where the ion milling left voids, an insulation layer and then the hard bias layer;
chemical mechanical polishing the hard bias and insulation layers to remove the hard bias and insulation layers from the cap layer and produce a planar top surface; and
plating a magnetic top shield above the read sensor stack and the hard bias layer that remains following the polishing.

16. The method of claim 15, wherein the cap layer includes one of rhodium (Rh) and chromium (Cr).

17. The method of claim 15, wherein the hard mask layer includes amorphous carbon.

18. The method of claim 15, wherein the cap layer includes one of rhodium (Rh) and chromium (Cr) and the hard mask layer includes amorphous carbon.

19. A method of forming a magnetoresistive (MR) read sensor, comprising:
providing a MR sensor stack with a polishing stop layer containing one of rhodium (Rh) and chromium (Cr) disposed above the MR sensor stack and a patterned mask layer containing amorphous carbon disposed above the polishing stop layer;
ion milling the MR sensor stack where unprotected by the mask layer;
reactive ion etching the mask layer to remove the patterned mask layer;
then, depositing hard bias magnetic material on the polishing stop layer and at sides of the MR sensor stack within voids defined by the ion milling; and
polishing to produce a planar top surface defined in part by the polishing stop layer.

20. The method of claim 19, further comprising depositing an electrical insulation layer on the polishing stop layer and both sides of the MR sensor stack, wherein the hard bias magnetic material is deposited on the insulation layer.
